(19) United States
(12) Patent Application Publication
(10) Pub. No.: US 2021/0133719 A1
(43) Pub. Date: May 6, 2021

(54) PRODUCT AND SERVICE CODE PROCESSING SYSTEM

(71) Applicant: SERVICE TRADING COMPANY, INC., Irvine, CA (US)

(72) Inventors: Todd Banhidy, Orange, CA (US); Matt Brunmeier, Corona Del Mar, CA (US)

(21) Appl. No.: 16/641,508

(22) PCT Filed: Aug. 24, 2018
(86) PCT No.: PCT/US2018/047851

§ 371 Date: Feb. 24, 2020

Related U.S. Application Data
(60) Provisional application No. 62/550,230, filed on Aug. 25, 2017.

(51) Int. Cl. G06Q 20/20; G06Q 50/10

(52) U.S. Cl. CPC G06Q 20/208; G06Q 20/202; G06Q 30/012; G06Q 50/10; G06Q 20/201; G06Q 20/204

(57) ABSTRACT

A point of sale computer system is coupled to a global computer network. Barcode data scanned from a single barcode is electronically received at the point of sale computer system. The barcode data comprises a product code for at least one product and a service code for at least one contractor service. A product price for the product code is automatically added to a sales total. A service price for the service code is automatically added to the sales total. The service code is electronically received at the point of sale computer system from a mapping computer system. The service code is derived by the mapping computing system configured to map the at least one product with the at least one contractor service. A sale is completed for the sales total.

### CROSS-REFERENCE TO RELATED APPLICATION

This application claims the benefit of U.S. Provisional Application No.: 62/550,230, filed Aug. 25, 2017, which is hereby incorporated by reference in its entirety.

### TECHNICAL FIELD

The present disclosure relates to point of sale computer systems, methods of completing a sale for at least one product with at least one contractor service, and instructions for point of sale computer systems to perform automated methods of completing a sale for at least one product with at least one contractor service.

### BACKGROUND

Many potential purchasers of products may hesitate purchasing products that may require a contractor service such as installation. Some contractors may not be certified (qualified) to perform a required service(s). Finding a certified contractor may be difficult for some purchasers. Finding an available contractor may be difficult for some purchasers. Many potential purchasers may be concerned about being overcharged by contractors. Many contractors may be concerned about getting paid by purchasers after a contracted service has been completed for the purchasers. Many potential purchasers may be uncomfortable disclosing banking information directly to contractors.

Many retailers recognize that some potential sales may be lost due to leaving the burden to purchasers to find a contractor to complete a required contractor service. Many retailers recognize the liability of recommending third-party contractors. Some retailers may enter into agreements with contractors directly. However, a plurality of third-party contractors in a plurality of locations covering a plurality of contractor service types may be needed to cover a plurality of products offered for sale through a plurality of retailers.

Automated systems are needed to improve the point of sale experience for purchasers of products and related contractor services.

### SUMMARY

The present invention provides a point of sale computer system in accordance with independent claim 1, and a data storage medium in accordance with independent claim 17. Preferred embodiments of the invention are reflected in the dependent claims.

The claimed invention can be better understood in view of the embodiments described and illustrated in the present disclosure, specifically in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

Some embodiments provide a point of sale computer system coupled to a global computer network and programmed to perform a method of completing a sale for at least one product with at least one contractor service. The method performed by the point of sale computer system comprises electronically receiving barcode data scanned from a single barcode, the barcode data comprising a product code for the at least one product and a service code for the at least one contractor service. The method may further comprise automatically adding a product price for the product code to a sales total. The method may further comprise automatically adding a service price for the service code to the sales total, the service code electronically received at the point of sale computer system from a mapping computer system, the service code derived by the mapping computing system configured to map the at least one product with the at least one contractor service. The method may further comprise completing the sale for the sales total.

The single barcode may be disposed to at least one of: the at least one product, and packaging accompanying the at least one product.

The single barcode may comprise a designator distinct from at least one additional barcode.

The single barcode may be generated before the sale is started.

The product code may represent at least one of: a product for sale, and a set of products for sale.

The at least one contractor service may comprise at least one of: at least one measurement, an installation, a delivery, an inspection, a warranty certification, a repair under warranty, and a replacement under warranty.

The service price may be based at least in part on location information of the point of sale computer system.

The method performed by the point of sale computer system may further comprise receiving purchaser data for a purchaser computer system.

The method performed by the point of sale computer system may further comprise electronically communicating terms of service to a purchaser computer system employing at least a portion of the purchaser data.

The method performed by the point of sale computer system may further comprise: electronically communicating terms of service to a purchaser computer system, electronically receiving an acceptance of the terms of service from the purchaser computer system, and electronically communicating the acceptance to a service processing computer system.

The method performed by the point of sale computer system may further comprise electronically completing the sale through employment of at least one merchant exchange computer system.

The method performed by the point of sale computer system may further comprise electronically communicating an electronic service request to a service processing computer system, the electronic service request comprising at least one of: purchaser data, product data, and service data.

The method performed by the point of sale computer system may further comprise electronically communicating a service order confirmation to a purchaser computer system.

The method performed by the point of sale computer system may further comprise electronically communicating a consumer feedback survey to a purchaser computer system.

The method performed by the point of sale computer system may further comprise electronically receiving consumer feedback survey data from a purchaser computer system.

Some embodiments provide a tangible, non-transitory data storage medium comprising indicia of instructions for a point of sale computer system to perform an automated method of completing a sale for at least one product with at least one contractor service. The point of sale computer system is coupled to a global computer network with access to at least one data storage device. The automated method performed according to the instructions comprises electronically receiving barcode data scanned from a single barcode, the barcode data comprising a product code for the at least one product and a service code for the at least one contractor service. The method may further comprise automatically adding a product price for the product code to a sales total. The method may further comprise automatically adding a service price for the service code to the sales total, the service code electronically received at the point of sale computer system from a mapping computer system, the service code derived by the mapping computing system configured to map the at least one product with the at least one contractor service. The method may further comprise completing the sale for the sales total.

The automated method performed according to the instructions may further comprise receiving purchaser data for a purchaser computer system.

The automated method performed according to the instructions may further comprise electronically communicating terms of service to a purchaser computer system employing at least a portion of the purchaser data.

The automated method performed according to the instructions may further comprise: electronically communicating terms of service to a purchaser computer system, electronically receiving an acceptance of the terms of service from the purchaser computer system, and electronically communicating the acceptance to a service processing computer system.

The automated method performed according to the instructions may further comprise electronically completing the sale through employment of at least one merchant exchange computer system.

The automated method performed according to the instructions may further comprise electronically communicating an electronic service request to a service processing computer system, the electronic service request comprising at least one of: purchaser data, product data, and service data.

The automated method performed according to the instructions may further comprise electronically communicating a service order confirmation to a purchaser computer system.

The automated method performed according to the instructions may further comprise electronically communicating a consumer feedback survey to a purchaser computer system.

The automated method performed according to the instructions may further comprise electronically receiving consumer feedback survey data from a purchaser computer system.

### BRIEF DESCRIPTION OF THE DRAWINGS

FIG. 1 is a block diagram showing an example point of sale computer system network as per an aspect of various embodiments.

FIG. 2 is a block diagram showing an example point of sale computer system network as per an aspect of various embodiments.

FIG. 3 is an example flow diagram of automatically adding a product code and a service code to a sales total as per an aspect of an embodiment.

FIG. 4 is a block diagram of an example computing environment in which aspects of embodiments of the present invention may be practiced.

### DETAILED DESCRIPTION OF EMBODIMENTS

Embodiments of the present disclosure may automatically add a product code and a service code to a sales total in a point of sale computer system. At least some of the embodiments may provide a more efficient process for purchasers purchasing products and related contractor services. At least some of the embodiments may provide a more effective process for retailers selling contractor services with related products.

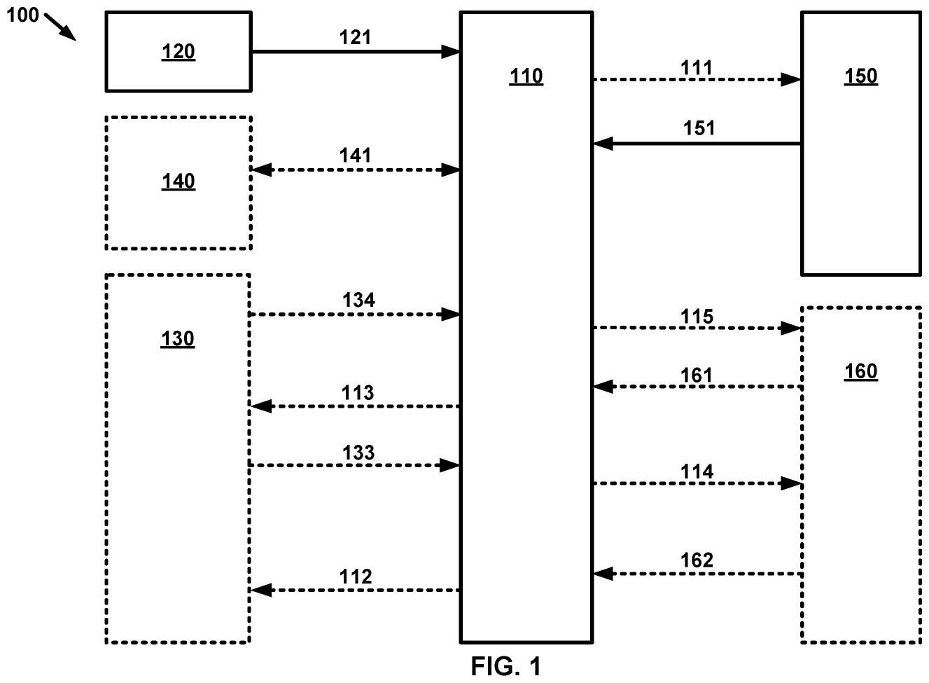

FIG. 1 is a block diagram showing an example point of sale computer system network 100 as per an aspect of various embodiments. The computer system network 100 may comprise at least one point of sale computer system 110, at least one purchaser computer system 130, and at least one mapping computer system 150. The at least one point of sale computer system 110, at least one purchaser computer system 130, and at least one mapping computer system 150 may communicate through employment of a global computer network (for example, the Internet). Communication through employment of the global computer network may employ at least one application, website, digital portal, Application Programming Interface (API), electronic message, digital file, combinations thereof, and/or the like. Purchaser computer system 130 may comprise multiple interconnected devices such as server(s), computer(s), mobile device(s), wearable device(s), combinations thereof, and/or the like.

According to an embodiment, at least one point of sale computer system 110 may be programmed to communicate a plurality of product codes 111 to at least one mapping computer system 150. The at least one mapping computer system 150 may be programmed to search the at least one point of sale computer system 110 for the plurality of product codes 111. For example, the at least one mapping computer system 150 may be programmed to search at least one webpage presented by the at least one point of sale computer system 110. The at least one webpage may comprise instructions configured to present information associated with a plurality of products.

According to an embodiment, each of a plurality of product codes 111 may represent a product for sale, a set of products for sale, combinations thereof, and/or the like. At least one mapping computer system 150 may be programmed to map each of at least some of the plurality of product codes to one of a plurality of service codes. At least one point of sale computer system 110 may be programmed to receive a plurality of service codes 151 from the at least one mapping computer system 150. Each of the plurality of service codes 151 may be mapped to at least one of the plurality of product codes 111. Each of the plurality of service codes 151 may be associated with one product or a set of products. Each of the plurality of service codes 151 may be based, at least in part, on at least one contractor service. The at least one contractor service may be based, at least in part, on at least a portion of the product information (for example, type of product), measurement required, assembly required, installation required, inspection required, at least one task required, at least one non-task, combinations thereof, and/or the like. At least some of the plurality of service codes 151 may be based, at least in part, on location information and/or contact information of a purchaser employing purchaser computer system 130. The location information and/or contact information may be electronically communicated from purchaser computer system 130. The location information and/or contact information may be communicated into point of sale computer system 110. For example, the location information and/or contact information may be keyed into point of sale computer system 110 by an operator of point of sale computer system 110. The location information and/or contact information may, for example, be keyed into point of sale computer system 110 by the purchaser. The location information and/or contact information may, for example, be communicated into point of sale computer system 110 from a data storage device. The data storage device may comprise shopper account information. The location information and/or contact information may, for example, be communicated into point of sale computer system 110 from merchant exchange computer system 140. Point of sale computer system 110 may increase efficiency for a purchaser of at least one product and at least one contractor service.

According to an embodiment, at least some of a plurality of service codes 151 may be based, at least in part, on location information of at least one point of sale computer system 110. Location information may be based, at least in part, on a browser setting, an IP address, GPS position information, at least one Wi-Fi network, combinations thereof, and/or the like. The location information may, for example, comprise a latitude, a longitude, a mailing address, a delivery address, a billing address, a phone number, combinations thereof, and/or the like. Each of the plurality of service codes 151 may relate to at least one service price. The at least one service price may be based, at least in part, on location information and/or contact information of a purchaser. The at least one service price may be based, at least in part, on the location information of the at least one point of sale computer system 110. The at least one service price may be based, at least in part, on the at least one contractor service. The at least one service price may be based, at least in part, on a contract with at least one certified contractor.

According to an embodiment, at least one point of sale computer system 110 may be programmed to receive barcode data 121. Barcode data 121 may be scanned from single barcode 120. Single barcode 120 may, for example, comprise a single code configured to designate a product code and a service code. Examples of single barcode 120 comprising a single code include: a UPC (Universal Product Code), a SKU (Stock Keeping Unit), and/or the like. Single barcode 120 may, for example, comprise both a service code and a product code directly embedded in the single barcode 120. An example of single barcode 120 comprising both a service code and a product code includes a QR (Quick Response) code.

According to an embodiment, a single barcode 120 may be disposed to at least one product, packaging accompanying at least one product, combinations thereof, and/or the like. For example, single barcode 120 may be printed on the at least one product. For example, single barcode 120 may be printed on a sticker attached to the at least one product or packaging accompanying the at least one product. For example, single barcode 120 may be printed on a card attached to: the at least one product or the packaging accompanying the at least one product. Single barcode 120 may be disposed to a product advertisement, contractor service card, contractor service advertisement, combinations thereof, and/or the like. Single barcode 120 may be generated before a sale is started. Single barcode 120 may be based, at least in part, on a predefined mapping. Single barcode 120 may be distinct from a barcode generated from a point of sale system in order to complete a sale or a transaction for a sale.

According to an embodiment, single barcode 120 may comprise a designator distinct from at least one additional barcode. For example, the designator may comprise text that designates single barcode 120 as comprising a product and a service. The text may, for example, comprise “Buy It Installed”, “Scan Here to Buy It Installed”, “This code includes installation from a third-party contractor”, combinations thereof, and/or the like.

According to an embodiment, at least one point of sale computer system 110 may be programmed to complete a sale with purchaser computer system 130. The sale may comprise an electronic transaction. Purchaser computer system 130 may be programmed to complete the sale with the at least one point of sale computer system 110.

According to an embodiment, at least one point of sale computer system 110 may be programmed to receive terms of service 161 from at least one service processing computer system 160. The at least one point of sale computer system 110 may be programmed to communicate the terms of service 113 to purchaser computer system 130. The at least one point of sale computer system 110 may be programmed to receive acceptance of the terms of service 133 from purchaser computer system 130. The at least one point of sale computer system 110 may be programmed to communicate the acceptance of the terms of service 114 to the at least one service processing computer system 160.

According to an embodiment, at least one point of sale computer system 110 may be programmed to communicate at least one electronic service request 115 to at least one service processing computer system 160. The at least one electronic service request 115 may be based, at least in part, on a purchase of at least one product with at least one contractor service. The purchase of the at least one product may be sold simultaneously with the purchase of the at least one contractor service. The purchase may be placed through employment of a keypad, keyboard, touch screen, scanner, credit and/or debit card terminal, digital portal, Application Programming Interface (API), combinations thereof, and/or the like. The keypad, keyboard, touch screen, scanner, credit and/or debit card terminal, digital portal, API, combinations thereof, and/or the like may be provided by the at least one point of sale computer system 110. The purchase may be based, at least in part, on barcode data 121. The barcode data may be produced by a scan of a UPC (Universal Product Code), a QR (Quick Response) code, a two-dimensional barcode, combinations thereof, and/or the like.

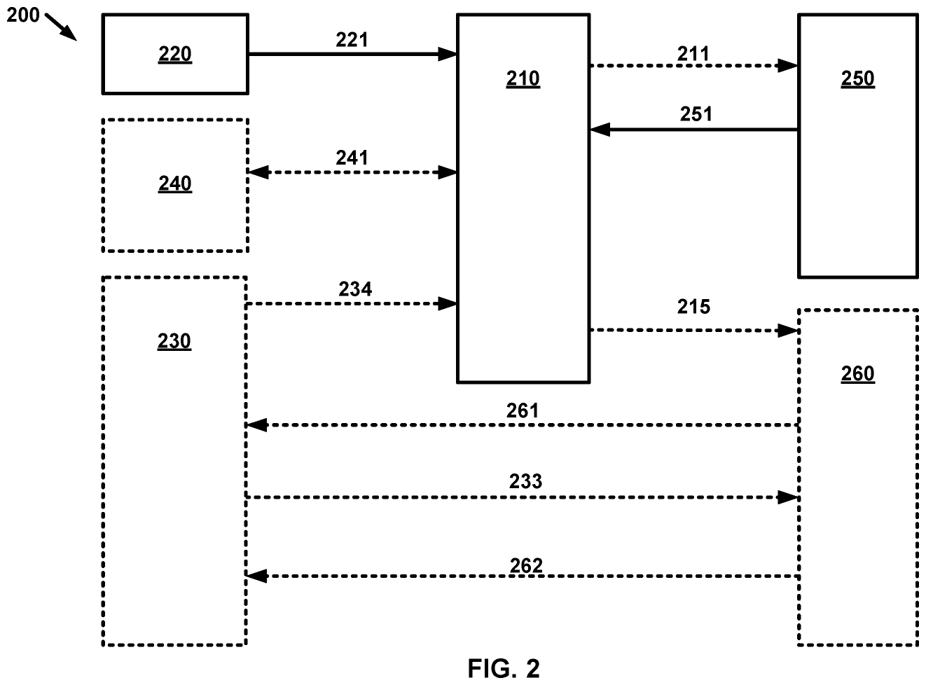

FIG. 2 is a block diagram showing an example point of sale computer system network 200 as per an aspect of various embodiments. The computer system network 200 may comprise at least one point of sale computer system 210, at least one purchaser computer system 230, and at least one mapping computer system 250. The at least one point of sale computer system 210, at least one purchaser computer system 230, and at least one mapping computer system 250 may communicate through employment of a global computer network. Purchaser computer system 230 may comprise multiple interconnected devices such as server(s), computer(s), mobile device(s), wearable device(s), combinations thereof, and/or the like.

According to an embodiment, at least one point of sale computer system 210 may be programmed to communicate a plurality of product codes 211 to at least one mapping computer system 250. The at least one mapping computer system 250 may be programmed to search the at least one point of sale computer system 210 for the plurality of product codes 211.

According to an embodiment, each of a plurality of product codes 211 may represent a product for sale, a set of products for sale, combinations thereof, and/or the like. At least one mapping computer system 250 may be programmed to map each of at least some of the plurality of product codes to one of a plurality of service codes. At least one point of sale computer system 210 may be programmed to receive a plurality of service codes 251 from the at least one mapping computer system 250. Each of the plurality of service codes 251 may be mapped to at least one of the plurality of product codes 211. Each of the plurality of service codes 251 may be associated with one product or a set of products. Each of the plurality of service codes 251 may be based, at least in part, on at least one contractor service. At least some of the plurality of service codes 251 may be based, at least in part, on location information and/or contact information of a purchaser employing purchaser computer system 230. The location information and/or contact information may be electronically communicated from purchaser computer system 230. The location information and/or contact information may be communicated into point of sale computer system 210. The location information and/or contact information may, for example, be communicated into point of sale computer system 210 from merchant exchange computer system 240. Point of sale computer system 210 may increase efficiency for a purchaser of at least one product and at least one contractor service.

According to an embodiment, at least some of a plurality of service codes 251 may be based, at least in part, on location information of at least one point of sale computer system 210. Each of the plurality of service codes 251 may relate to at least one service price. The at least one service price may be based, at least in part, on the location information of the at least one point of sale computer system 210.

According to an embodiment, at least one point of sale computer system 210 may be programmed to receive barcode data 221. Barcode data 221 may be scanned from single barcode 220. Single barcode 220 may comprise a designator distinct from at least one additional barcode.

According to an embodiment, at least one point of sale computer system 210 may be programmed to complete a sale with purchaser computer system 230. The sale may comprise an electronic transaction. Purchaser computer system 230 may be programmed to complete the sale with the at least one point of sale computer system 210.

According to an embodiment, at least one service processing computer system 260 may be programmed to communicate terms of service 261 to purchaser computer system 230. Terms of service 261 may be based, at least in part, on at least a portion of purchaser data 234 received in an electronic service request 215. The at least one service processing computer system 260 may be programmed to electronically receive an acceptance of the terms of service 233 from purchaser computer system 230.

According to an embodiment, at least one service processing computer system 260 may be programmed to communicate electronic service order confirmation 262 to a purchaser. The purchaser may employ purchaser computer system 230. Electronic service order confirmation 262 may be based, at least in part, on at least a portion of purchaser data 234 received in an electronic service request 215. The at least one service processing computer system 260 may be programmed to electronically communicate a consumer feedback survey to the purchaser. The at least one service processing computer system 260 may be programmed to electronically receive consumer feedback survey data from purchaser computer system 230.

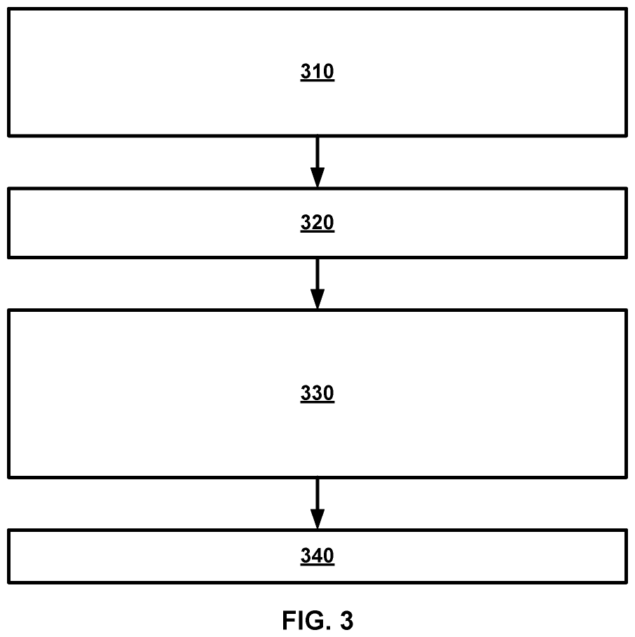

FIG. 3 is an example flow diagram of automatically adding a product code and a service code to a sales total as per an aspect of an embodiment. A point of sale computer system (for example, 110 and 210) may be coupled to a global computer network. The point of sale computer system (for example, 110 and 210) may be programmed to perform a method of completing a sale for at least one product with at least one contractor service. The point of sale computer system (for example, 110 and 210) may electronically receive barcode data (for example, 121 and 221) at 310. The barcode data (for example, 121 and 221) may be scanned from a single barcode (for example, 120 and 220). The barcode data (for example, 121 and 221) may comprise a product code for the at least one product and a service code for the at least one contractor service. The service code (for example, 151 and 251) may be electronically received at the point of sale computer system (for example, 110 and 210) from a mapping computer system (for example, 150 and 250). The service code (for example, 151 and 251) may be automatically derived by the mapping computing system (for example, 150 and 250) programmed to map the at least one product with the at least one contractor service. The service code (for example, 151 and 251) may be based, at least in part, on the product code (for example, 111 and 211) and/or product information related to the at least one product. The service code (for example, 151 and 251) may be received from the mapping computer system (for example, 150 and 250) prior to scanning the barcode data (for example, 121 and 221). For example, a plurality of service codes (for example, 151 and 251) may be mapped to a plurality of product codes (for example, 111 and 211) for a plurality of products offered for sale with contractor services.

According to an embodiment, a service code (for example, 151 and 251) may be received from a mapping computer system (for example, 150 and 250) after receiving barcode data (for example, 121 and 221). For example, a point of sale computer system (for example, 110 and 210) may be programmed to request a service code (for example, 151 and 251) for a specific product code (for example, 111 and 211) from the mapping computer system (for example, 150 and 250). The point of sale computer system (for example, 110 and 210) may, for example, be programmed to download a service code (for example, 151 and 251) for a specific product code (for example, 111 and 211) from the mapping computer system (for example, 150 and 250).

According to an embodiment, a the point of sale computer system (for example, 110 and 210) may automatically add a product price for a product code (for example, 111 and 211) to a sales total at 320. The point of sale computer system (for example, 110 and 210) may automatically add a service price for a service code (for example, 151 and 251) to the sales total at 330. The service code (for example, 151 and 251) may be electronically received at the point of sale computer system (for example, 110 and 210) from a mapping computer system (for example, 150 and 250). The service code (for example, 151 and 251) may be derived by the mapping computing system (for example, 150 and 250). The mapping computing system (for example, 150 and 250) may be configured to map the at least one product with the at least one contractor service.

According to an embodiment, a point of sale computer system (for example, 110 and 210) may electronically complete a sale for a sales total at 340.

According to an embodiment, a point of sale computer system (for example, 110 and 210) may receive purchaser data (for example, 134 and 234) for a purchaser computer system (for example, 130 and 230). The purchaser data (for example, 134 and 234) may be communicated from the purchaser computer system (for example, 130 and 230). The purchaser data (for example, 134 and 234) may comprise contact information. The contact information may, for example, comprise a mobile phone number, a mobile identification number, an email address, an IP address, a URL, combinations thereof, and/or the like. The purchaser data (for example, 134 and 234) may comprise location information. The location information may be based, at least in part, on a browser setting, an IP address, GPS position information, at least one Wi-Fi network, combinations thereof, and/or the like. The location information may, for example, comprise a latitude, a longitude, a mailing address, a delivery address, a billing address, combinations thereof, and/or the like.

According to an embodiment, a point of sale computer system (for example, 110 and 210) may electronically communicate an electronic service request (for example, 115 and 215) to a service processing computer system (for example, 160 and 260). The electronic service request (for example, 115 and 215) may comprise product data, service data, at least a portion of purchaser data (for example, 134 and 234), combinations thereof, and/or the like. The product data may comprise at least one product code (for example, 111 and 211). The electronic service request (for example, 115 and 215) may comprise service data on at least one contractor service. The service data may comprise at least one service code (for example, 151 and 251). The electronic service request (for example, 115 and 215) may be based, at least in part, on a purchase of at least one product with at least one contractor service. The electronic service request (for example, 115 and 215) may comprise at least one target service date and/or time period. The service processing computer system (for example, 160 and 260) may request additional contact information and/or location information directly from a purchaser employing a purchaser computer system (for example, 130 and 230).

According to an embodiment, a point of sale computer system (for example, 110) may electronically communicate terms of service (for example, 113) to a purchaser computer system (for example, 130). The terms of service (for example, 161) may be received from a service processing computer system (for example, 160). Communicating the terms of service (for example, 113) to the purchaser computer system (for example, 130) may employ at least a portion of purchaser data (for example, 134). The point of sale computer system (for example, 110) may electronically receive an acceptance of the terms of service (for example, 133) from the purchaser computer system (for example, 130). The point of sale computer system (for example, 110) may electronically communicate the acceptance (for example, 114) to the service processing computer system (for example, 160). The service processing computer system (for example, 160) may be implemented as a module of a mapping computer system (for example, 150). The point of sale computer system (for example, 110) may electronically communicate a service order confirmation (for example, 112) to a purchaser computer system (for example, 130). The service order confirmation (for example, 162) may be received from a service processing computer system (for example, 160). Communicating the service order confirmation (for example, 112) to the purchaser computer system (for example, 130) may employ at least a portion of purchaser data (for example, 134). The point of sale computer system (for example, 110) may electronically communicate a consumer feedback survey to the purchaser computer system (for example, 130). The consumer feedback survey may be electronically communicated with a service receipt. The sale computer system (for example, 110) may electronically receive consumer feedback survey data from the purchaser computer system (for example, 130). The consumer feedback survey data may, for example, comprise at least one satisfaction rating for at least one third-party contractor and/or purchased contractor service. The point of sale computer system (for example, 110) may electronically communicate the consumer feedback survey data to the service processing computer system (for example, 160).

According to an embodiment, a service processing computer system (for example, 260) may electronically communicate terms of service (for example, 261) to a purchaser computer system (for example, 230). Communicating the terms of service (for example, 261) to the purchaser computer system (for example, 230) may employ at least a portion of purchaser data (for example, 234) received in an electronic service request (for example, 215). The service processing computer system (for example, 260) may electronically receive an acceptance of the terms of service (for example, 233) from the purchaser computer system (for example, 230).

According to an embodiment, a service processing computer system (for example, 260) may electronically communicate an electronic service order confirmation (for example, 262) to a purchaser. The purchaser may employ a purchaser computer system (for example, 230). Electronically communicating an electronic service order confirmation (for example, 262) may comprise at least a portion of purchaser data (for example, 234). The service processing computer system (for example, 260) may electronically communicate a consumer feedback survey to the purchaser. The service processing computer system (for example, 260) may electronically receive consumer feedback survey data from the purchaser computer system (for example, 230).

According to an embodiment, at least one contractor service may comprise at least one measurement, assembly of at least one product, an installation, a delivery, an inspection, a warranty certification, a repair under warranty, maintenance, a replacement under warranty, combinations thereof, and/or the like. The at least one measurement may be associated with a proposed installation of at least one product. The at least one product may comprise a new product, a factory refurbished product, a third party refurbished product, a dealer refurbished product, a distributor refurbished product, an open box product, new old stock, a used product, combinations thereof, and/or the like. The delivery may comprise a product in addition to a purchased product, a product in exchange for the purchased product, a replacement under warranty product, combinations thereof, and/or the like. The inspection may be associated with a proposed installation of the at least one product. The warranty certification may be associated with an installed product and/or installation of the at least one product. The repair under warranty may be associated with an installed product. The replacement under warranty may be associated with an installed product and/or the at least one product.

According to an embodiment, a purchase may comprise a completed sale or financial transaction. The purchase of at least one product may be transacted simultaneously (or near simultaneously) with the purchase of at least one contractor service. The at least one product may comprise a new product, a retail product, a product that may require at least one contractor service, combinations thereof, and/or the like.

According to an embodiment, each of at least one service code may be mapped to a classification of service required. A standardization of contractor services may comprise a plurality of service codes. Each of the plurality of service codes may comprise at least one task. At least one of the plurality of service codes may comprise at least one non-task. A non-task may comprise a task that may not be included in with a contractor service and/or service code. The standardization may comprise a mapping of contractor services to service codes. The standardization may comprise a mapping of products to service codes. At least one of the plurality of service codes may comprise at least one additional task (in other words, an add-on). The standardization may comprise at least one pricing standard. The at least one pricing standard may be based, at least in part, on at least one location, median income of the at least one location, skills required to complete at least one contractor service associated with a service code, an expected number of third-party contractors required to complete at least one contractor service associated with a service code, combinations thereof, and/or the like.

According to an embodiment, a point of sale computer system (for example, 110 and 210) may electronically complete a sale through employment of at least one merchant exchange computer system (for example, 140 and 240). The point of sale computer system (for example, 110 and 210) may electronically receive sale data (for example, 141 and 241) from at least one merchant exchange computer system (for example, 140 and 240).

According to an embodiment, a tangible, non-transitory data storage medium may comprise an indicia of instructions for a point of sale computer system (for example, 110 and 210) to perform an automated method of completing a sale for at least one product with at least one contractor service. The point of sale computer system (for example, 110 and 210) may be coupled to a global computer network with access to at least one data storage device. The automated method performed according to the instructions may comprise electronically receiving barcode data (for example, 121 and 221) scanned from a single barcode (for example, 120 and 220), the barcode data (for example, 121 and 221) comprising a product code (for example, 111 and 211) for the at least one product and a service code (for example, 151 and 251) for the at least one contractor service. The single barcode (for example, 120 and 220) may be generated before the sale is started. The automated method performed according to the instructions may comprise automatically adding a product price for the product code (for example, 111 and 211) to a sales total. The automated method performed according to the instructions may comprise automatically adding a service price for the service code (for example, 151 and 251) to the sales total, the service code (for example, 151 and 251) electronically received at the point of sale computer system (for example, 110 and 210) from a mapping computer system (for example, 150 and 250), the service code (for example, 151 and 251) derived by the mapping computing system (for example, 150 and 250) configured to map the at least one product with the at least one contractor service. The automated method performed according to the instructions may comprise completing the sale for the sales total. The automated method performed according to the instructions may comprise electronically completing the sale in electronic communication with a purchaser computer system (for example, 130 and 230).

According to an embodiment, a service processing computer system (for example, 160 and 260) may automatically select a certified contractor. The service processing computer system (for example, 160 and 260) may automatically select the certified contractor based, at least in part, on location information of a purchaser, a purchaser computer system (for example, 130 and 230), a point of sale computer system (for example, 110 and 210), combinations thereof, and/or the like. The location information may be: specified in an electronic service request (for example, 115 and 215), communicated from the point of sale computer system (for example, 110 and 210), part of a list of locations available for contractor services, combinations thereof, and/or the like. The service processing computer system (for example, 160 and 260) may automatically select the certified contractor based, at least in part, on availability of at least one certified contractor. The availability may be matched to one of at least one target service date and/or time period. The availability may be matched to one of at least one target service date and matched to at least one adjacent time period. The availability may, for example, be based, at least in part, on a number of jobs (scheduled and/or completed) per hour, day, week, combinations thereof, and/or the like. The availability may, for example, be based, at least in part, on a number of work hours per day (scheduled and/or completed) and/or work hours per week (scheduled and/or completed). The availability may, for example, be based, at least in part, on availability data. At least one contractor service type may, for example, comprise a category of contractor services (for example, electrical) and/or at least one skill set associated with at least one category (for example, residential electrical). The service processing computer system (for example, 160 and 260) may automatically select the certified contractor based, at least in part, on a minimum satisfaction rating.

According to an embodiment, a point of sale computer system (for example, 110 and 210) may be managed, for example, by a manufacturer, wholesaler, merchant, retailer, combinations thereof, and/or the like. A purchaser may employ at least one purchaser computer system (for example, 130 and 230) to complete at least one purchase. The purchaser may, for example, be a consumer (for example, residential, wholesale, commercial, and/or business).

According to an embodiment, a service processing computer system (for example, 160 and 260) may automatically create an electronic service work order. The electronic service work may be based, at least in part, on an electronic service request (for example, 115 and 215). The electronic service work order may comprise service work order information. The service work order information may comprise at least a portion of purchaser data (for example, 134 and 234), at least a portion of product data, at least a portion of service data, at least a portion of contractor payment data, combinations thereof, and/or the like. The purchaser data (for example, 134 and 234) may comprise contact information for a purchaser. The contact information may be provided by the purchaser through employment of a purchaser computer system (for example, 130 and 230). The contact information may be downloaded from a data storage device accessible by a point of service computer system (for example, 110 and 210). The data storage device may comprise account information associated with the purchaser. Product data may comprise data on at least one purchased product. Service data may comprise data on at least one purchased contractor service. Contractor payment data may comprise a payment offered for at least one certified contractor for completing at least one contractor service.

According to an embodiment, a service processing computer system (for example, 160 and 260) may electronically receive service progress data from at least one of a plurality of contractor devices. The service progress data may be associated with at least one contractor service specified in an electronic service work order. The service progress data may comprise at least one service date. The service progress data may comprise information associated with at least one closing event. The at least one closing event may comprise closing information required by a certified contractor to validate completion of at least one contractor service. The closing information may comprise a code, a photographic file, time spent on site, at least one completed task, at least one additional task required to complete the at least one completed task, at least one expense, combinations thereof, and/or the like. At least one closing event may be required prior to releasing funds paid by a purchaser to the certified contractor for completing at least a portion of at least one of the at least one contractor service. Funds may be held by a manager of a point of sale computer system (for example, 110 and 210), a manager of a merchant exchange computer system (for example, 140 and 240), a manager of the service processing computer system (for example, 160 and 260), a contractor service provider, combinations thereof, and/or the like. The funds may be held in an electronically accessible escrow trust account. The funds may be transferred to the certified contractor through employment of banking information.

According to an embodiment, a service processing computer system (for example, 160 and 260) may automatically generating a contractor network report. The contractor network report may comprise performance information for at least one certified third party contractor and/or an established network of certified third party contractors. The performance data may, for example, comprise at least one average fulfillment rate, at least one average time to assignment, an average cost of at least one contractor service, combinations thereof, and/or the like. The contractor network report may comprise service data related to at least one electronic service request (for example, 115 and 215), at least one product code (for example, 111 and 211), at least one service code (for example, 151 and 251), combinations thereof, and/or the like. The service processing computer system (for example, 160 and 260) may electronically communicate the contractor network report to a manager of a point of sale computer system (for example, 110 and 210). Electronically communicating the contractor network report may comprise a mobile phone number, a mobile identification number, an email address, an IP address, a URL, combinations thereof, and/or the like.

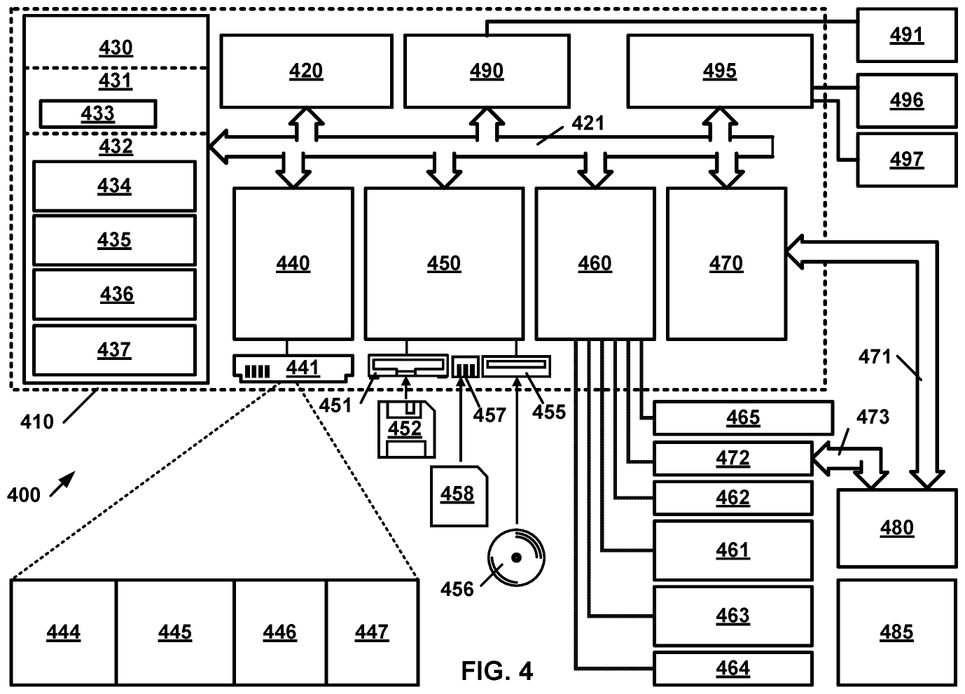

FIG. 4 is a block diagram of an example computing environment in which aspects of embodiments of the present invention may be practiced. The computing environment may comprise computing device 410. Components of computing device 410 may include, but are not limited to, a processing unit 420, a system memory 430, and a system bus 421 that couples various system components including the system memory 430 to the processing unit 420.

Computing device 410 may comprise a variety of computer readable media. Computer readable media may be available media accessible by computing device 410 and may include both volatile and nonvolatile media, removable and non-removable media. By way of example, and not limitation, computer readable media may comprise computer storage media and communication media. Computer storage media may comprise both volatile and nonvolatile, removable and non-removable media implemented in a method or technology for storage of information such as computer readable instructions, data structures, program modules, other data, combinations thereof, and/or the like. Computer storage media may comprise, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, and/or any other medium which may be employed to store information and which may be accessed by computer 410. Communication media may comprise computer readable instructions, data structures, program modules and/or other data in a modulated data signal such as a carrier wave and/or other transport mechanism and may comprise information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above may also be included within the scope of computer readable media.

The system memory 430 may comprise computer storage media in the form of volatile and/or nonvolatile memory such as ROM 431 and RAM 432. A basic input/output system 433 (BIOS), containing the basic routines that help to transfer information between elements within computer 410, such as during start-up, may be stored in ROM 431. RAM 432 may comprise data and/or program modules that may be accessible to and/or presently being operated on by processing unit 420. By way of example, and not limitation, FIG. 4 illustrates operating system 434, application programs 435, other program modules 436, and program data 437.

The computing device 410 may also comprise other removable/non-removable volatile/nonvolatile computer storage media. By way of example only, FIG. 4 illustrates a hard disk drive 441 that may read from or write to non-removable, nonvolatile magnetic media, a magnetic disk drive 451 that may read from or write to a removable, nonvolatile magnetic disk 452, a flash drive reader 457 that may read flash drive 458, and an optical disk drive 455 that may read from or write to a removable, nonvolatile optical disk 456 such as a CD ROM or other optical media. Other removable/non-removable, volatile/nonvolatile computer storage media that may be used in the operating environment include, but are not limited to, magnetic tape cassettes, flash memory cards, digital versatile disks, digital video tape, solid state RAM, solid state ROM, and the like. The hard disk drive 441 may be connected to the system bus 421 through a non-removable memory interface such as interface 440, and magnetic disk drive 451 and optical disk drive 455 may be connected to the system bus 421 by a removable memory interface, such as interface 450.

The drives and their associated computer storage media discussed above and illustrated in FIG. 4 provide storage of computer readable instructions, data structures, program modules and other data for the computer 410. In FIG. 4, for example, hard disk drive 441 is illustrated as storing operating system 444, application programs 445, program data 447, and other program modules 446. Additionally, for example, non-volatile memory may include instructions for presenting images on a display 491 of computing device 400 and/or the like. Similarly, non-volatile memory may comprise instructions for causing the presentation of images on the display of a remote computing device 480 and/or the like. Display 491 and touch input 465 may be integrated into the same device.

A user may enter commands and information into computing device 410 through input devices such as a touch input device 465, a keyboard 462, a microphone 463, a camera 464, and a pointing device 461, such as a mouse, trackball or touch pad. These and other input devices may be connected to the processing unit 420 through interface 460 coupled to system bus 421, but may be connected by other interface and bus structures, such as a parallel port, game port or a universal serial bus (USB). A display 491 or other type of display device may be connected to the system bus 421 via an interface, such as a video interface 490. Other devices, such as, for example, speakers 497 and printer 496 may be connected to the system via output interface 495.

The computing device 410 may be operated in a networked environment using logical connections to one or more remote computers, such as a remote computer 480. Remote computer 480 may be a personal computer, a hand-held device, a server, a router, a network PC, a peer device or other common network node, and typically includes many or all of the elements described above relative to the computing device 410. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computing device 410 is connected to the LAN 471 through a network interface or adapter 470. When used in a WAN networking environment, the computing device 410 may comprise a modem 472 or other means for establishing communications over the WAN 473, such as the Internet. The modem 472, which may be internal or external, may be connected to the system bus 481 via interface 460, or other appropriate mechanism. The modem 472 may be wired or wireless. Examples of wireless devices may comprise, but are not limited to: Wi-Fi and Bluetooth. In a networked environment, program modules depicted relative to the computing device 410, or portions thereof, may be stored in the remote memory storage device. By way of example, and not limitation, FIG. 4 illustrates remote application programs 485 as residing on remote computer 480. It will be appreciated that the network connections shown are presented as examples only and other means of establishing a communications link between the computers may be used.

There is thus provided, in accordance with an embodiment of the present disclosure, a point of sale computer system coupled to a global computer network. The point of sale computer system may be programmed to perform a method of completing a sale for at least one product with at least one contractor service. The method performed by the point of sale computer system may comprise electronically receiving barcode data scanned from a single barcode. The barcode data may comprise a product code for the at least one product and a service code for the at least one contractor service. The method may further comprise automatically adding a product price for the product code to a sales total. The method may further comprise automatically adding a service price for the service code to the sales total. The service code may be electronically received at the point of sale computer system from a mapping computer system. The service code may be derived by the mapping computing system. The mapping computing system may be configured to map the at least one product with the at least one contractor service. The method may further comprise completing the sale for the sales total.

According to an embodiment, a tangible, non-transitory data storage medium may comprise indicia of instructions for a point of sale computer system to perform an automated method of completing a sale for at least one product with at least one contractor service. The point of sale computer system may be coupled to a global computer network with access to at least one data storage device. The automated method performed according to the instructions may comprise electronically receiving barcode data scanned from a single barcode. The barcode data may comprise a product code for the at least one product and a service code for the at least one contractor service. The method may further comprise automatically adding a product price for the product code to a sales total. The method may further comprise automatically adding a service price for the service code to the sales total. The service code may be electronically received at the point of sale computer system from a mapping computer system. The service code may be derived by the mapping computing system. The mapping computing system may be configured to map the at least one product with the at least one contractor service. The method may further comprise completing the sale for the sales total.

According to an embodiment, a single barcode may be disposed to at least one product, packaging accompanying at least one product, combinations thereof, and/or the like.

According to an embodiment, a single barcode may comprise a designator. The designator may be distinct from at least one additional barcode.

According to an embodiment, a single barcode may be generated before a sale is started.

According to an embodiment, a product code may represent a product for sale, a set of products for sale, combinations thereof, and/or the like.

According to an embodiment, at least one contractor service may comprise at least one measurement, an installation, a delivery, an inspection, a warranty certification, a repair under warranty, a replacement under warranty, combinations thereof, and/or the like.

According to an embodiment, a service price may be based at least in part on location information of a point of sale computer system.

According to an embodiment, a method may comprise receiving purchaser data for a purchaser computer system.

According to an embodiment, a method may comprise electronically communicating terms of service to a purchaser computer system employing at least a portion of purchaser data.

According to an embodiment, a method may comprise electronically communicating terms of service to a purchaser computer system. The method may comprise electronically receiving an acceptance of the terms of service from the purchaser computer system. The method may comprise electronically communicating the acceptance to a service processing computer system.

According to an embodiment, a method may comprise electronically completing a sale through employment of at least one merchant exchange computer system.

According to an embodiment, a method may comprise electronically communicating an electronic service request to a service processing computer system. The electronic service request may comprise purchaser data, product data, service data, combinations thereof, and/or the like.

According to an embodiment, a method may comprise electronically communicating a service order confirmation to a purchaser computer system.

According to an embodiment, a method may comprise electronically communicating a consumer feedback survey to a purchaser computer system.

According to an embodiment, a method may comprise electronically receiving consumer feedback survey data from a purchaser computer system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “a”, “an”, and “one” are not to be interpreted as “only one”. References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (in other words, hardware with a biological element) or a combination thereof, all of which may be behaviorally equivalent. For example, modules may be implemented using computer hardware in combination with software routine(s) written in a computer language (Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines, and/or the like. The processing hardware may be configured to execute instructions. The instructions may be stored on a machine-readable medium. According to some embodiments, the machine-readable medium (for example, automated data medium) may be a medium configured to store data in a machine-readable format that may be accessed by an automated sensing device. Examples of machine-readable media include: magnetic disks, cards, tapes, and drums, flash memory, memory cards, electrically erasable programmable read-only memory (EEPROM), solid state drives, optical disks, barcodes, magnetic ink characters, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, computer systems have been described as including server(s), computer(s), mobile device(s), and/or wearable device(s). However, one skilled in the art will recognize that the relationships between server(s), computer(s), mobile device(s), and/or wearable device(s) may vary from a traditional server/device relationship over a global network such as the Internet. For example, a server may be collective based: portable equipment, broadcast equipment, virtual, application(s) distributed over a broad combination of computing sources, part of a cloud, and/or the like. Similarly, for example, a mobile device may be a user based client, portable equipment, broadcast equipment, virtual, application(s) distributed over a broad combination of computing sources, part of a cloud, integrated with at least one wearable device, and/or the like. Similarly, at least one wearable device may be configured to operate as a mobile device. Additionally, it should be noted that, for example purposes, several of the various embodiments may employ instructions operating in conjunction with hardware devices. However, one skilled in the art will recognize that many various languages and frameworks may be employed to build and use embodiments of the present invention. For example, languages/frameworks may be based upon Java, HTML, XML, PHP, Python, ActionScript, JavaScript, Ruby, Prolog, SQL, VBScript, Visual Basic, Perl, C, C++, Objective-C, combinations thereof, and/or the like.

In this specification, various embodiments are disclosed. Limitations, features, and/or elements from at least some of the disclosed example embodiments may be combined to create further embodiments within the scope of the disclosure. Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A point of sale computer system coupled to a global computer network and programmed to perform a method of completing a sale for at least one product with at least one contractor service, the method performed by the point of sale computer system comprising:
a) electronically receiving barcode data scanned from a single barcode, the barcode data comprising a product code for the at least one product and a service code for the at least one contractor service;
b) automatically adding a product price for the product code to a sales total;
c) automatically adding a service price for the service code to the sales total, the service code electronically received at the point of sale computer system from a mapping computer system, the service code derived by the mapping computing system configured to map the at least one product with the at least one contractor service; and
d) completing the sale for the sales total.

2. The system according to claim 1, wherein the single barcode is disposed to at least one of:
a) the at least one product; and
b) packaging accompanying the at least one product.

3. The system according to claim 1, wherein the single barcode comprises a designator distinct from at least one additional barcode.

4. The system according to claim 1, wherein the single barcode is generated before the sale is started.

5. The system according to claim 1, wherein the product code represents at least one of:
a) a product for sale; and
b) a set of products for sale.

6. The system according to claim 1, wherein the at least one contractor service comprises at least one of:
a) at least one measurement;
b) an installation;
c) a delivery;
d) an inspection;
e) a warranty certification;
f) a repair under warranty; and
g) a replacement under warranty.

7. The system according to claim 1, wherein the service price is based at least in part on location information of the point of sale computer system.

8. The system according to claim 1, wherein the service price is based at least in part on location information of a purchaser, the location information communicated into the point of sale computer system.

9. The system according to claim 1, wherein the method performed by the point of sale computer system further comprises receiving purchaser data for a purchaser computer system.

10. The system according to claim 9, wherein the method performed by the point of sale computer system further comprises electronically communicating terms of service to a purchaser computer system employing at least a portion of the purchaser data.

11. The system according to claim 1, wherein the method performed by the point of sale computer system further comprises:
a) electronically communicating terms of service to a purchaser computer system;
b) electronically receiving an acceptance of the terms of service from the purchaser computer system; and
c) electronically communicating the acceptance to a service processing computer system.

12. The system according to claim 1, wherein the method performed by the point of sale computer system further comprises electronically completing the sale through employment of at least one merchant exchange computer system.

13. The system according to claim 1, wherein the method performed by the point of sale computer system further comprises electronically communicating an electronic service request to a service processing computer system, the electronic service request comprising at least one of:
a) purchaser data;
b) product data; and
c) service data.

14. The system according to claim 1, wherein the method performed by the point of sale computer system further comprises electronically communicating a service order confirmation to a purchaser computer system.

15. The system according to claim 1, wherein the method performed by the point of sale computer system further comprises electronically communicating a consumer feedback survey to a purchaser computer system.

16. The system according to clim 1, wherein the method performed by the point of sale computer system further comprises electronically receiving consumer feedback survey data from a purchaser computer system.

17. A tangible, non-transitory data storage medium comprising indicia of instructions for a point of sale computer system to perform an automated method of completing a sale for at least one product with at least one contractor service, wherein the point of sale computer system is coupled to a global computer network with access to at least one data storage device, the automated method performed according to the instructions comprising:
a) electronically receiving barcode data scanned from a single barcode, the barcode data comprising a product code for the at least one product and a service code for the at least one contractor service;
b) automatically adding a product price for the product code to a sales total;
c) automatically adding a service price for the service code to the sales total, the service code electronically received at the point of sale computer system from a mapping computer system, the service code derived by the mapping computing system configured to map the at least one product with the at least one contractor service; and
d) completing the sale for the sales total.

18. The medium according to claim 17, wherein the single barcode is generated before the sale is started.
